(19) United States
(12) Patent Application Publication
(10) Pub. No.: US 2016/0029149 A1
(43) Pub. Date: Jan. 28, 2016

(54) LOW POWER CONSUMPTION SHORT RANGE WIRELESS COMMUNICATION SYSTEM

(71) Applicant: GH9 CO., LTD., Tokyo (JP)

(72) Inventors: Hidenori MORIKAWA, Tokyo (JP); Takashi MATSUYAMA, Tokyo (JP)

(21) Appl. No.: 14/776,027

(22) PCT Filed: Sep. 24, 2014
(86) PCT No.: PCT/JP2014/004880

§ 371 Date: Sep. 14, 2015

(30) Foreign Application Priority Data
Sep. 26, 2013 (JP) 2013-199881

(51) Int. Cl. H04W 4/00; H04W 76/02; H04W 8/00

(52) U.S. Cl. CPC H04W 4/008; H04W 8/005; H04W 76/02; H04W 84/18

(57) ABSTRACT

[PROBLEMS]

To provide a low-power-consumption short-range wireless communication system enabling wireless communication devices to perform ad hoc communication without necessitating it to have a server (central device).

[MEANS FOR SOLVING PROBLEMS]

The inventors have focused on transmission to detect connection destination in the proximity which is performed before establishing connection in low-power-consumption short-range wireless communication systems, e.g. advertisement packets (or scan packets) in the Bluetooth Low Energy communication system. The inventors have designed a mechanism in which various information including an identifier unique to a device is transmitted in attachment to the above packets thereby enabling the devices to perform a high-speed and ad-hoc communication.

### TECHNICAL FIELD

The present invention relates to a low-power-consumption short-range wireless communication system in which communication units perform wireless communication with one another in accordance with the wireless communication standards low power consumption short range wireless communication such as Bluetooth (Registered Trademark) Low Energy. More particularly, the present invention relates to a low power consumption short range wireless communication system which enables communication units to perform ad-hoc wireless communication with one another without necessitating it to have a (central) server.

### BACKGROUND ART

The development of mobile communication terminals in recent years has promoted use of wireless communication devices. In order to further improve the convenience of users, newer methods for wireless communication are sought.

Currently, in the neighborhood of users, there are numerous kinds of communication devices which are capable of performing wireless communication such as mobile phones, mobile music players, headsets, watches, fitness devices and domestic medical devices (e.g. heart rate meters).

PAN (Personal Area Network) is a proposed concept that describes wireless connection modes between the personal wireless communication devices such as in the above. PAN is characterized by its wireless connection mode that enables wireless communication with low power consumption, small device size, low cost, low communication speed, low communication frequency, low data volume in a short range such as in the range of 20 m to 30 m.

In particular, established and put into practical use as communication standards are Bluetooth Low Energy, ZigBee™, UWB (Ultra Wide Band) and ANT/ANT+. Also established as communication standards is Bluetooth 4.0 which integrates Bluetooth Low Energy with Bluetooth 3.0, the conventional standard.

Among the above-described communication standards, Bluetooth Low Energy is the representative standard. Bluetooth Low Energy is a communication standard established by the Bluetooth SIG, a standard body of Bluetooth, which uses 2.4 GHz bands and allows communication speed of 1 Mbps with transmission power of 10 mW to −10 μW in a range of 150 m according to its specification.

The communication protocol of Bluetooth Low Energy is as follows.

Data Transmission

Data is transmitted in the form of packets at intervals of the predetermined time period.

Data can be broadcasted.

The distance from the transmitter device can be calculated based on the reception signal intensity of the received packets.

The devices do not conduct paring (connection authentication) with each other.

Connecting Operation

A (peripheral) device searching for connection destination sends (broadcast) advertisement packets using the advertisement channels to detect connection destination by receiving response packets from the nearby devices.

A (central) device to which connection is requested receives (scans) radio waves on the advertisement channels to obtain advertisement packets transmitted therein (passive scan) or to send a connection request (scan packets) responsive to the advertisement packets and establish connection (active scan). By sending scan packets including SCAN_REQ, it is possible to receive further information which could not be included in the advertisement packets.

Network Topology

There are two roles for the devices, central and peripheral. A device can be central or peripheral but it cannot have the both roles at the same time. A device, however, can have the role of peripheral in the advertizing mode and central in the scanning mode at the same time.

A peripheral device is allowed to connect to only one central device at the same time. A central device is allowed to connect to one or more peripheral devices at the same time.

Having such features of communication protocols as in the above, Bluetooth Low Energy is suitable for low-frequency and immediate-response (low latency) communication.

Disclosed in the below-referenced Patent Document 1 is a wireless communication system between wireless communication devices in accordance with the standard for low-power-consumption short-range wireless communication such as Bluetooth Low Energy.

### PRIOR ART DOCUMENTS

### Patent Document

Patent Document 1: Japanese Patent Laid-open No. 2012-142877.

### DISCLOSURE OF THE INVENTION

### Problems to be Solved by the Invention

In the low-power-consumption short-range wireless communication systems such as Bluetooth Low Energy, the packets to detect connection destination (the above-mentioned advertisement packets) are sent out at considerably short intervals of time. In the Bluetooth Low Energy communication system, up to 50 packets can be sent out in a second at a minimum time interval of 20 milliseconds.

Nevertheless, it takes several seconds to establish connection with the device receiving the packets. This is due to the necessity of controlling the network topology between the devices.

For example, the Bluetooth Low Energy communication system is under the restrictions that a device cannot have the both roles of central and peripheral at the same time, that a peripheral device is allowed to connect to only one central device at the same time and that a central device is allowed to connect to one or more peripheral devices at the same time. In case the attribute information of the connection source is changed, it is required again to establish connection with the device receiving the packets and obtain information therefrom. In order for a device to have the both roles of central and peripheral at the same time, the device is required to avoid establishing connection which violates the above restrictions by detecting and avoiding collision with connection request from other devices during a predetermined standby time, thereby connection is acknowledged.

In the low-power-consumption short-range wireless communication systems used as a wireless PAN between various kinds of personal devices, the fact that it requires several seconds for establishing connection means that the users are forced to stop on the spot and to wait or stop their actions.

In practice, however, the users carrying the wireless communication devices ceaselessly moves around inside the houses or facilities. This means that such cases are assumed that connection can not be established because the users once initiating connecting operation moves out of the communication area before connection is established. In the above cases, the wireless communication system can not be fully utilized.

On the other hand, there is always relationship of peripheral and central between the devices and a central device always transmits data to initiate communication according to the standards of Bluetooth Low Energy. This means that peripheral devices placed in a proximity communication range can not have any interaction therebetween without having a prepared central device.

In consideration of the above inconveniences of the prior art low-power-consumption short-range wireless communication systems, it is an object of the present invention to provide a low-power-consumption short-range wireless communication system enabling a novel method of connection and communication to dissolve the above-mentioned inconveniences.

### Means for Solving the Problems

As a result of earnest study in consideration of the above problem, the inventors have focused on transmission to detect connection destination in the proximity which is performed before establishing connection in low-power-consumption short-range wireless communication systems, e.g. advertisement packets (or scan packets) in the Bluetooth Low Energy communication system. The inventors have designed a mechanism in which various information including an identifier unique to a device is transmitted in attachment to the above packets thereby enabling the devices to perform a high-speed and ad-hoc communication. Thus, the present invention has been accomplished.

According to the present invention, there is provided a low-power-consumption short-range wireless communication system in which a wireless communication device in the state of establishing no connection sends packets to detect other wireless communication devices to be connection destination, the packets including identifier of said wireless communication device and optional communication data.

According to the present invention, there is also provided a low-power-consumption short-range wireless communication system in which a wireless communication device in the state of establishing no connection sends packets for detecting other wireless communication devices to be connection destination, the packets including identifier of said wireless communication device and optional communication data; and another wireless communication device receiving said packets in the state of establishing no connection responsively sends packets for detecting other wireless communication devices to be connection destination, the packets including identifier of said another wireless communication device and optional communication data.

The low-power-consumption short-range wireless communication system according to the present invention is characterized in that said packets for detecting other wireless communication devices having data lengths smaller than the predetermined data field length include the optional communication data in the vacant area of the data field.

The low-power-consumption short-range wireless communication system according to the present invention is also characterized in that the communication system is standards of Bluetooth Low Energy communication system; and a wireless communication device in the state of establishing no connection sends advertisement packets to detect other wireless communication devices to be connection destination, the packets including identifier of said wireless communication device and optional communication data.

The low-power-consumption short-range wireless communication system according to the present invention is also characterized in that the communication system is standards of Bluetooth Low Energy communication system; and a wireless communication device in the state of establishing no connection sends packets for detecting other wireless communication devices to be connection destination, the packets including identifier of said wireless communication device and optional communication data in a time-division multiplexing manner; and another wireless communication device receiving said packets in the state of establishing no connection restores the time-division multiplexed communication data to obtain said identifier of said wireless communication device and said optional communication data.

The low-power-consumption short-range wireless communication system according to the present invention is also characterized in that the communication system is standards of Bluetooth Low Energy communication system; and a wireless communication device in the state of establishing no connection sends packets for detecting other wireless communication devices to be connection destination, the packets including identifier of said wireless communication device and optional communication data in a time-division multiplexing manner; and another wireless communication device receiving said packets in the state of establishing no connection restores the time-division multiplexed communication data to obtain said identifier of said wireless communication device and said optional communication data. The low-power-consumption short-range wireless communication system according to the present invention is also characterized in that the wireless communication devices mutually perform ad hoc communication without having a role of central or peripheral.

### Effects of the Invention

As described in the above, the present invention provides a low-power-consumption short-range wireless communication system in which wireless communication devices are capable of transmitting the identifier of the wireless communication devices and optional communication data even in the state of establishing no connection. This means that the communication system allows various modes of ad hoc communication to transmit small amount of data at high speed.

Furthermore, the communication system allows ad hoc communication without any restriction by the relative roles (central/peripheral, master/slave, server/client and the like) of the wireless communication devices because the wireless communication devices are in the state of establishing no connection. This is a mode of communication which was not able to be realized by the commonly-used wireless communications such as Wi-Fi and by the conventional low-power-consumption short-range wireless communication systems such as Bluetooth Low Energy.

### BRIEF DESCRIPTION OF THE DRAWINGS

FIG. 1 is a schematic view showing a low-power-consumption short-range wireless communication system according to the present invention.

FIG. 2 is a sequence diagram showing the flow of operation by wireless communication devices at the start of communication in the low-power-consumption short-range wireless communication system according to the present invention.

FIG. 3 is a frame format diagram showing the structures of advertisement packets sent by the wireless communication devices in the low-power-consumption short-range wireless communication system according to the present invention.

FIG. 4 is a frame format diagram showing the structures of advertisement packets sent by the wireless communication devices in the low-power-consumption short-range wireless communication system according to the present invention.

FIG. 5 is an explanatory view showing an example using the low-power-consumption short-range wireless communication system according to the present invention in a store.

FIG. 6 is a schematic view showing a P2P system using the low-power-consumption short-range wireless communication system according to the present invention.

### BEST MODE FOR CARRYING OUT THE INVENTION

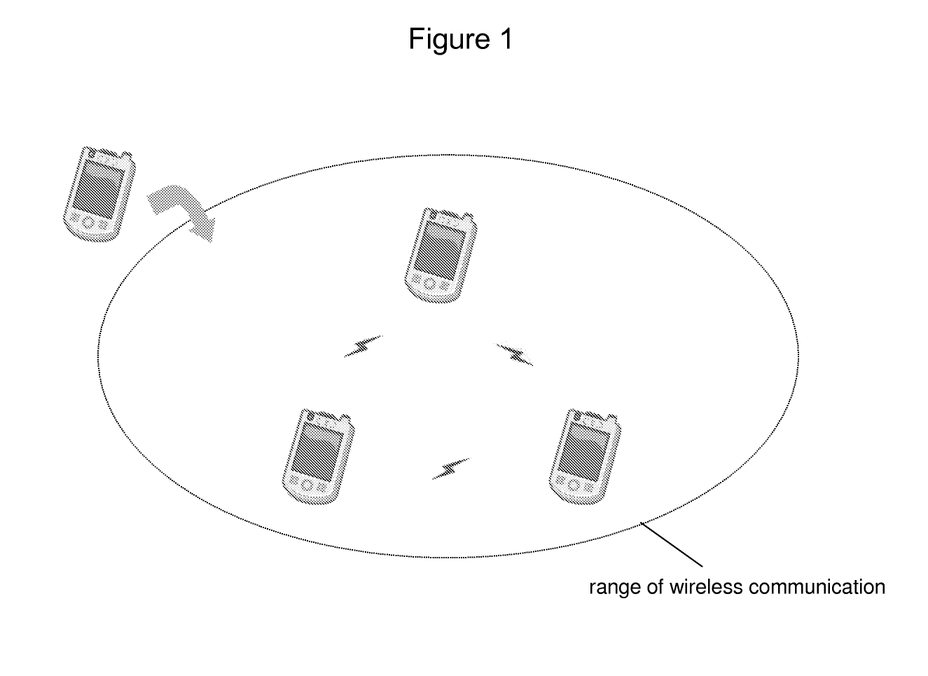

Described hereinafter with reference to the attached figures are detailed embodiments for carrying out the low-power-consumption short-range wireless communication system according to the present invention. In the FIGS. 1 to 6 illustrating exemplary embodiments of the present invention, like reference numerals refer to like members which have similar basic composition and operation.

### System Configuration

FIG. 1 is a schematic view showing an embodiment of the low-power-consumption short-range wireless communication system according to the present invention. Below described is an embodiment in which wireless communication devices are mounted with Bluetooth Low Energy modules (hereinafter simply referred to as “wireless terminals”) are employed to perform low-power-consumption short-range wireless communication.

As shown in FIG. 1, wireless terminals mutually in the range of wireless communication perform wireless communication in accordance with the standards of Bluetooth Low Energy. In the present embodiment, any types of devices can be employed as a wireless terminal as long as it is capable of incorporating Bluetooth Low Energy modules. Although smart phones, mobile phones and wireless access point devices are shown as examples in FIG. 1, it is possible to employ various types of movable wireless communication devices other than the above examples, e.g. portable music players, headsets, watches, fitness machines and domestic medical apparatus.

In the present embodiment of the low-power-consumption short-range wireless communication system, the wireless terminals mounted with application software for wireless communication in accordance with the standards of Bluetooth Low Energy are capable of performing communication operations as described in the following.

### Communication Between Wireless Terminals

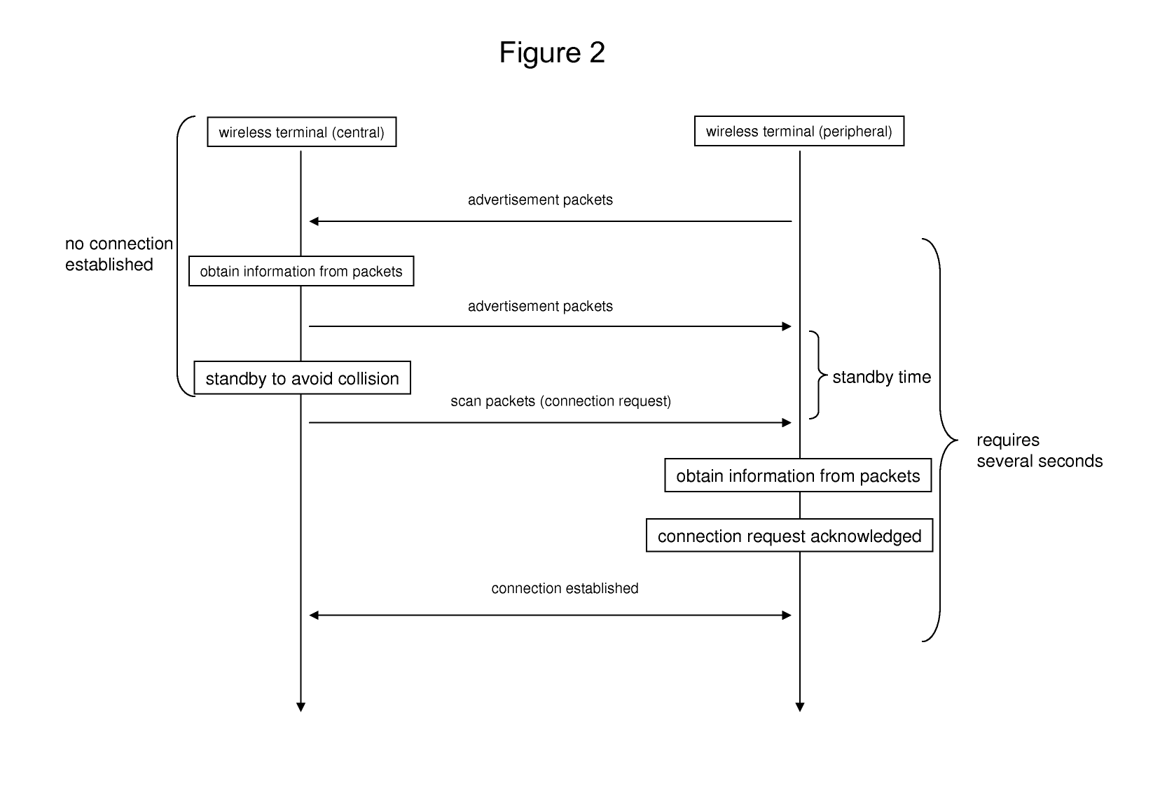

FIG. 2 is a sequence diagram showing the flow of operation by wireless communication devices at the start of communication in the low-power-consumption short-range wireless communication system according to the present invention.

In FIG. 2, a peripheral wireless terminal constantly broadcasts advertisement packets on an advertisement channel having a predetermined frequency (up to 50 packets are sent out in a second at a minimum time interval of 20 milliseconds.).

A central wireless terminal receiving the advertisement packets from the peripheral wireless terminal obtains information included in the packets. The central wireless terminal attempting to connect to the peripheral wireless terminal first sends out advertisement packets for avoiding collision. This advertisement packets are broadcasted so as to inhibit other central wireless terminal from sending connection request to the peripheral wireless terminal.

In case collision is not detected for a predetermined time period, the central wireless terminal sends scan packets including connection request.

The peripheral wireless terminal receiving the scan packets from the central wireless terminal obtains information included in the packets and acknowledge/reject the connection request. In case of acknowledging the connection request, the peripheral wireless terminal performs predetermined operation (Initiation) to establish connection.

Above described is a connection mode in which a central wireless terminal sends connection request to a peripheral wireless terminal. It is also possible to design a connection mode in which a connection mode in which a peripheral wireless terminal sends connection request to a central wireless.

Conventionally, it has been considered that substantive communication can be performed only after connection is established. According to the present invention, however, the inventors have focused on the fact that wireless terminals transmit information even in a connectionless state before establishing connection and have designed a mechanism allowing the wireless terminals to mutually perform some communication in a connectionless state before establishing no connection.

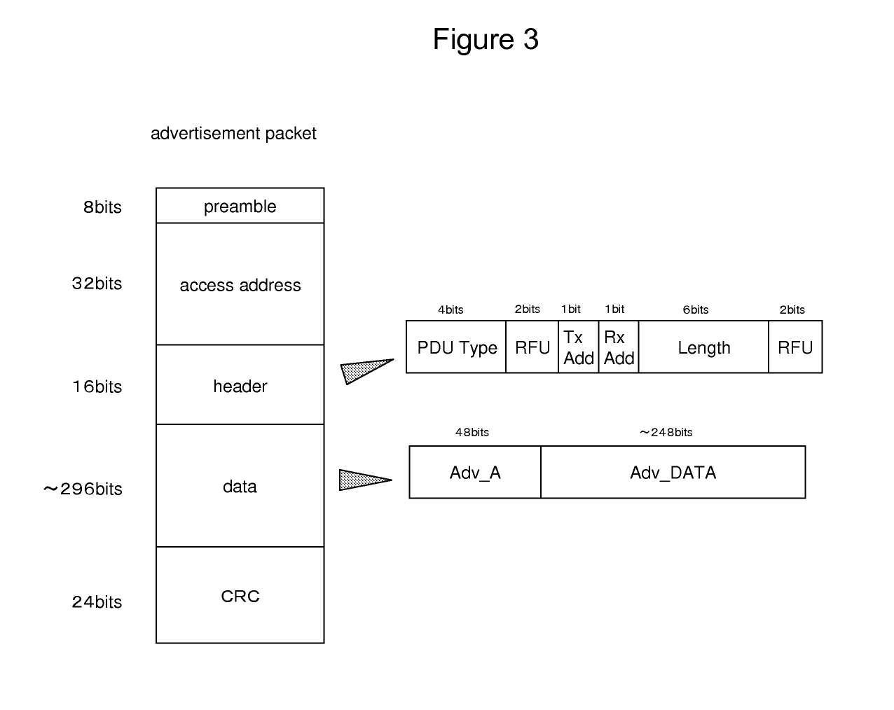

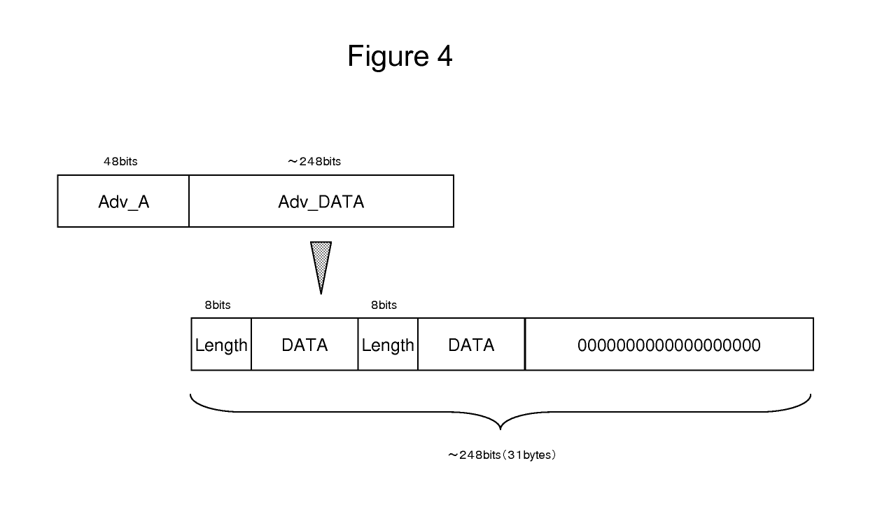

FIGS. 3 and 4 are frame format diagrams showing the structures of advertisement packets.

As shown in FIG. 3, an advertisement packet in the link layer consists of a preamble, an access address, a header, a data part and a CRC. The header and the data part form an advertising PDU.

The header consists of a PDU (Protocol Data Unit) Type describing the type of PDU data, TxAdd describing the identifier of the transmitter terminal, RxAdd describing the identifier of the receiver terminal, Length describing the length of the subsequent data and RFU (Reserved for Future Use) having no specific use. The length of the header is 16 bits (2 bytes).

As shown in FIG. 4, the data part (payload part) consists of an Adv_A and an Adv_DATA. The Adv_A describes the address of the advertiser and the Adv_DATA contains the advertising data.

A plurality sets of data can be contained in the Adv_DATA. In this case, the Length describing the length of the subsequent data and the data are interspliced in the Adv_DATA. The maximum length of the Adv_DATA is 248 bits (31 bytes). In case the data length is less than the above maximum length, it has been decided that the remaining field is zero-filled.

The present invention allows the wireless terminals to perform mutual communication concurrently with the transmission and reception of the advertisement packets. Thus, the wireless terminals are capable of communicating with on another in a connectionless state before establishing no connection.

The advertisement packets include such information as a UUDI (Universal Unique ID) uniquely assigned to each wireless terminal and various types of data according to the purpose of use. The advertisement packets may include, for example, a unique ID set for respective service, attribute information of the user or the wireless terminal, information of the communication sate of the wireless terminal and the like. Such information is preferably included in the UUID having a length of 128 or more.

In case a packet has only several bytes of data filed available, the information can be divided and embedded into a plurality of packets. In such cases, conventional mechanism of dividing and integrating data can be employed.

According to the above-described mechanism, the wireless terminals are capable of performing arbitrary communication in a connectionless state before establishing no connection. This is significantly advantageous in that it enables communication using the advertisement packets in tens of micro seconds or so in comparison with the above-described case where it takes several seconds to wait for the establishment of connection to initiate communication. Furthermore, because such a mode of communication is in the state of having no connection and has no restriction by the central/peripheral relationship between the terminals enables, the peripheral wireless terminals are capable of mutually perform ad hoc communication.

### EXAMPLES

It is possible to utilize in various ways the low-power-consumption short-range wireless communication system according to the present invention as described in the above. Below are the examples.

### Customer Relationship Management Tools for Stores

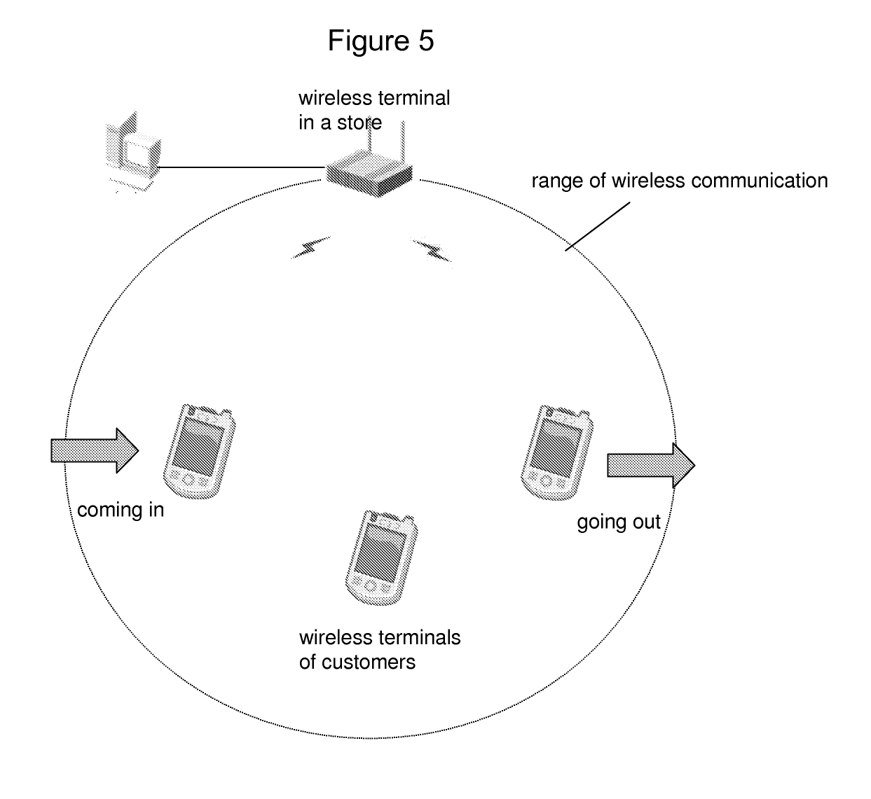

FIG. 5 is an explanatory view showing an example using the low-power-consumption short-range wireless communication system according to the present invention in a store.

In FIG. 5, a store is equipped with a wireless terminal having a communication range which covers the whole area of the store and capable of performing wireless communication with wireless terminals owned by customers coming into the store. Although a fixed terminal is shown in FIG. 5, the store may be equipped with various kinds of communication devices.

Either the wireless terminal of the store or a wireless terminal of a customer wireless terminal can initiate wireless communication. Described in the following is a case where a customer wireless terminal initiates wireless communication (see FIG. 2).

A customer wireless terminal constantly broadcasts advertisement packets at intervals of a predetermined time period. The advertisement packets includes the following information in the data fields which has not been in use hitherto (the data fields shown as “00000 . . . ” in FIG. 4);

service ID, user ID, renewal date of user information, state of communication of terminal, attribute information of user, etc., and
store ID, renewal date of store information, state of communication of terminal, attribute information of store, message from store, etc.

The above attribute information of user may include such information as name (nickname), address, gender, age, occupation, personal preferences and so on.

The store terminal receiving advertisement packets from a customer terminal obtains the user information as described in the above and sends advertisement packets in response thereto. The customer terminal receiving responsive advertisement packets obtains the store information. (This information can be obtained without necessitating it to wait for receipt of the scan packets as shown in FIG. 2.)

Thus, the store terminal and the customer terminal in a connectionless state before establishing no connection can mutually perform communication promptly (within tens of milliseconds).

For example, an O2O (Online to Offline) promotion tool is provided in which a store terminal sends advertisement packets including the website address of the store so as to access to guide access to the website. In case of visitor promotion campaign of stores, it is possible to confirm the customers actually visiting the stores (For example, this mechanism can be utilized as an entrance authentication tool in the “electronic ticket management system” disclosed in Japanese Patent Application No. 2012-180292).

The store terminal may send different advertisement packets to each of the customer terminals h rather than broadcasting the same advertisement packets. For example, the store terminal may distribute information or coupons for specific age group or gender, send notification of birthday's privilege or send personal messages using the customers name such as “Dear Mr. XX, Thank you for visiting our store.” based on the obtained attribute information of the customers. In this way the system works as a communication tool with high added value.

Furthermore, as shown in FIG. 5, the store terminal may be connected to a personal computer so as to store the obtained information in the personal computer. For example, numbers of visits, purchase history, movement history and staying time can be stored to provide an effective customer relationship management tools.

The customer terminals may also store information received from the store terminal. In this case, the store can make such events to occur as coupon issued when the customer visits the store 5 times.

In the same way, the system can be introduced into the point confirmation terminals of supermarkets. This is advantageous in that the cards can be dispensed with and the customers do not have to wait in line before the point confirmation terminals.

### Ad hoc Communication

Taking the advantage of the low-power-consumption short-range wireless communication system according to the present invention in that ad hoc communication can be performed, various services can be provided.

In case the system is applied to a store such as in the above, wireless communication can be performed not only between the store terminal and the customer terminals but also between the customer terminals. For example, the system may promote communication between the customers present in the same store at the same time.

Not only in stores, but also in playhouses, party places, event places and the like, the system may promote ad hoc communication between the participants. For example, the system may match the participants having similar attribute information so as to trigger communication therebetween.

In any place other than the above, it is possible to promote communication between the users having wireless terminals and coming into the proximity to one another.

### Communication Terminal Authentication System

The low-power-consumption short-range wireless communication system according to the present invention can be utilized as a terminal (user) authentication system.

In this case, it is possible to conceal the communication contents by transmitting data encrypted by the private key of the transmitter terminal while disclosing the public key in the advertisement packets.

This allows each of the terminals to conceal the communication contents from the others even in case of performing ad hoc communication as described in the above. This means that it is made possible to exchange personal information using an open communication system in an open place. There is thus provided a novel P2P platform using mobile terminals such as smart phones.

### Mobile Signage (Digital Signage)

Digital signage is a technique of dynamically and interactively altering image and information (ads and the like) displayed on planar displays or projector screens using digital communication.

The low-power-consumption short-range wireless communication system according to the present invention can be utilized such that a wireless terminal can send instruction to dynamically alter the displayed contents (mobile signage). That is, a display device functioning as a wireless terminal receives advertisement packets from another wireless terminal coming into the communication range of the display device and alters the displaying images according to the information attached thereto, enabling it to develop video advertising in response to the situation on the spot. Employing the present system, such a situation is prevented that only one user occupies the display as is often the case with the conventional mobile signage system.

### Complementary Tool of Location Information System

The low-power-consumption short-range wireless communication system according to the present invention can be utilized so as to function as a complementary tool for computer systems obtaining and utilizing location information such as GPS and Geofence.

There has been a problem that it is impossible to obtain precise location information within doors. The system can provide complementary information, for example, by equipping wireless terminals with GPS by the windows which obtain location information of the wireless terminals moving within doors. The system may also substitute the IMES (Indoor MEssaging System).

### Watching Tool

The low-power-consumption short-range wireless communication system according to the present invention can be utilized such that the wireless terminals function as watching tools for old people and small children.

A watching wireless terminal continuously monitors the wireless terminal carried by the watched person in the communication range and raises the alarm in case the watching wireless terminal fails to receive advertisement packets from the wireless terminal carried by the watched person. In this system, it is possible to detect unusual incidents on the watched person in real time by continuous monitoring (50 times per second) in a connectionless state.

### P2P (SNS) Tools

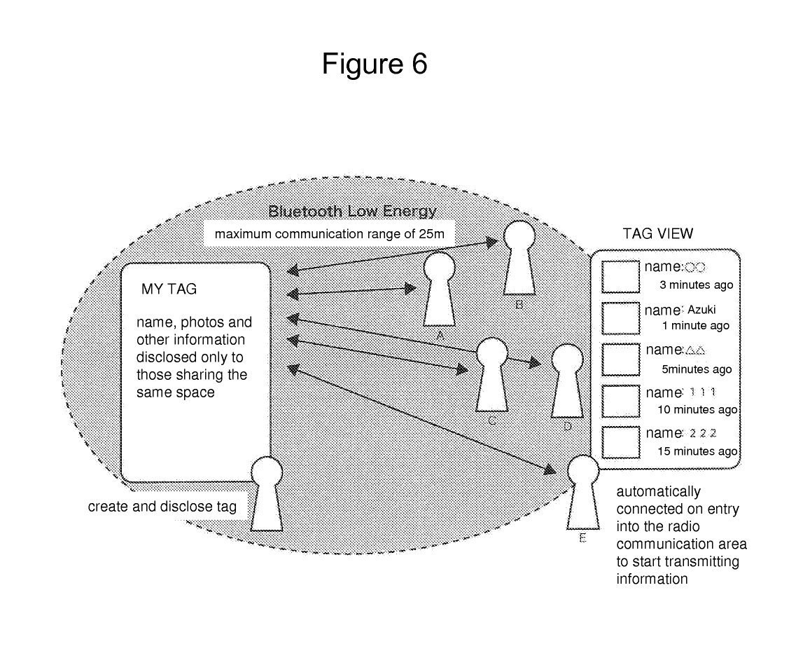

FIG. 6 is a schematic view showing a P2P (SNS) system using the low-power-consumption short-range wireless communication system according to the present invention.

In FIG. 6, a wireless terminal of a user broadcasts in attachment to advertisement packets predetermined information (tag) such as user name (nickname), photograph, attribute information, comments and the like for other wireless terminals in the communication range. The other wireless terminals receive this the above information in a connectionless state. The user can obtain information of the other users in the proximity from the responsive advertisement packets. The user may start communication with any of the other users. It is preferable to conceal the communication contents transmitted between the wireless terminals.

It is also possible to notify change of status of a user by attaching such information to advertisement packets. Specifically, it is possible to by collating the data stored in the receiver terminal and the time stamp (or flags) of the advertisement packets of the transmitter terminal.

The P2P (SNS) system using the low-power-consumption short-range wireless communication system according to the present invention is advantageous in that information communication is performed immediately (within several tens of seconds) in a connectionless state and that communication logs do not remain on any server of a third party.

In practice, the system can be utilized as a tool for promoting communication between the customers in restaurants, playhouses and social places. Because the system is server-less, the stores do not have to prepare any special devices and all it takes is to provide the places. It is also possible, however, to equip a store terminal to obtain information of the trends of the users.

### INDUSTRIAL APPLICABILITY

As shown in FIGS. 1 to 4, the low-power-consumption short-range wireless communication system according to the present invention is realized by the OS, application software, databases, network systems and the like which are built on the hardware resources of computers comprising CPUs, memories, auxiliary storage devices, display devices, I/O devices and the like such that the system concretely realizes connectionless communication through the packet data transmitted between the wireless communication devices by using the above hardware resources. The present invention, thus, constitutes a creation of technical ideas utilizing a law of nature, which can be utilized in the filed of software and information communication and the like.

1. A low-power-consumption short-range wireless communication system in which a wireless communication device in the state of establishing no connection sends packets to detect other wireless communication devices to be connection destination, the packets including identifier of said wireless communication device and optional communication data.

2. A low-power-consumption short-range wireless communication system in which a wireless communication device in the state of establishing no connection sends packets for detecting other wireless communication devices to be connection destination, the packets including identifier of said wireless communication device and optional communication data; and
another wireless communication device receiving said packets in the state of establishing no connection responsively sends packets for detecting other wireless communication devices to be connection destination, the packets including identifier of said another wireless communication device and optional communication data.

3. The low-power-consumption short-range wireless communication system according to claim 1, wherein said packets for detecting other wireless communication devices having data lengths smaller than the predetermined data field length include the optional communication data in the vacant area of the data field.

4-8. (canceled)

9. The low-power-consumption short-range wireless communication system according to claim 2, wherein said packets for detecting other wireless communication devices having data lengths smaller than the predetermined data field length include the optional communication data in the vacant area of the data field.

10. The low-power-consumption short-range wireless communication system according to claim 3, wherein the communication system is standards of Bluetooth Low Energy communication system; and
a wireless communication device in the state of establishing no connection sends advertisement packets to detect other wireless communication devices to be connection destination, the packets including identifier of said wireless communication device and optional communication data.

11. The low-power-consumption short-range wireless communication system according to claim 3, wherein the communication system is standards of Bluetooth Low Energy communication system; and
a wireless communication device in the state of establishing no connection sends packets for detecting other wireless communication devices to be connection destination, the packets including identifier of said wireless communication device and optional communication data in a time-division multiplexing manner; and another wireless communication device receiving said packets in the state of establishing no connection restores the time-division multiplexed communication data to obtain said identifier of said wireless communication device and said optional communication data.

12. The low-power-consumption short-range wireless communication system according to claim 4, wherein the wireless communication devices mutually perform ad hoc communication without having a role of central or peripheral.

13. The low-power-consumption short-range wireless communication system according to claim 5, wherein the wireless communication devices mutually perform ad hoc communication without having a role of central or peripheral.
